(19) United States
(12) Patent Application Publication
(10) Pub. No.: US 2013/0179197 A1
(43) Pub. Date: Jul. 11, 2013

(54) LARGE SCALE FACILITATION OF INCOME INSURANCE USING INDEPENDENT UNDERLYING INVESTMENTS

(71) Applicant: Aria Retirement Solutions, Inc., San Francisco, CA (US)

(72) Inventors: Jay Miller, Napa, CA (US); Leonard J. Stecklow, Tiburon, CA (US); David E. Stone, Lafayette, CA (US); Robert Scott Strait, Oakland, CA (US)

(73) Assignee: Aria Retirement Solutions, Inc., San Francisco, CA (US)

(21) Appl. No.: 13/734,727

(22) Filed: Jan. 4, 2013

Related U.S. Application Data
(60) Provisional application No. 61/584,182, filed on Jan. 6, 2012.

(51) Int. Cl. G06Q 40/06; G06Q 40/08

(52) U.S. Cl. CPC G06Q 40/06; G06Q 40/08
USPC 705/4

(57) ABSTRACT

An independent investment platform receives a request from an investor to purchase an income insurance product offered by an insurance company. In response, the independent investment platform monitors an investment account for use with the income insurance product. The investment account is held by a custodian and the investment account is independent of the insurance company.

### RELATED APPLICATIONS

This application claims the benefit of U.S. Provisional Patent Application No. 61/584,182 filed Jan. 6, 2012, the entire contents of which is hereby incorporated by reference.

### TECHNICAL FIELD

This disclosure relates to the field of computerized financial systems and, in particular, to management of insurance income-guarantees when the underlying investments are not managed by the insurance company.

### BACKGROUND

The number of individuals reaching retirement age is steadily increasing over time. Many of these individuals are struggling to obtain financially secure retirement. Retirement savings has been exposed to severe, sustained market declines in recent times. Consequently, as retirees live longer, more and more retirement savings will be depleted.

Overall trends related to retirement finances include the public becoming much better educated about retirement planning and lifetime income solutions. In addition, financial professionals are moving toward a fee-based, fiduciary relationship with their clients. Furthermore, the government is becoming extremely supportive of private sector initiatives that will supplement social security and provide retirees with guaranteed lifetime income.

As a result of these trends, Insurance income-guarantees are becoming a critical component to retirement planning. Products that are particularly appealing are those that allow investors to purchase income guarantees while still reaping gains from stock market appreciation. Traditional products, however, such as variable annuities, are complex, require the investor to place their assets in proprietary products, and have very high switching and surrender costs.

The standalone living benefit (SALB) and similar new products provide the benefits of variable annuities, are simple to understand, and have little or no surrender fees. These products guarantee income for life, although they do not guarantee the principal, and protect this income from market declines. Currently, only a few SALB products are available and those are only offered through very limited distribution channels. In addition, the investments used with these income insurance products are conventionally controlled, managed and/or held in custody by the insurance company offering the income guarantee. The investor has no control what investments are made and is subject to the custody platforms selected by the insurer.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary network architecture in which embodiments of the present disclosure may be implemented.

FIG. 2 is a block diagram illustrating an independent investment platform, according to an embodiment.

FIG. 3 is a flow diagram illustrating a method for enrollment in an income insurance policy using an independent investment platform, according to an embodiment.

FIG. 4 is a flow diagram illustrating a method for verifying investments for use with an income insurance policy using an independent investment platform, according to an embodiment.

FIG. 5 is a flow diagram illustrating a maintenance method for monitoring independent investments used with an income insurance policy, according to an embodiment.

FIG. 6 is a flow diagram illustrating a method for benefit payments from an income insurance policy using an independent investment platform, according to an embodiment.

FIG. 7 is a block diagram illustrating an exemplary computer system, according to an embodiment.

### DETAILED DESCRIPTION

Embodiments are described for large scale facilitation of income insurance using independent underlying investments. In one embodiment, standalone living benefit (SALB) products, which may also be known as contingent deferred annuities, and other similar income insurance products have underlying investment asset that are separate and independent from the SALB insurance contract and may be held at a custodian of the investors choosing, while still maintaining an insurer issued guarantee of lifetime income. In one embodiment, the monitoring and management services provided by the independent investment platform described herein may be used with any income insurance product that is regulated as an annuity contract under the applicable state insurance law. The investor will have a choice of independent investment vehicles, allow a choice of custodians for the investment(s), allow for switching of investments without disturbing the insurance income guarantee, and eliminate reliance on a single insurer through reinsurance of the income guarantees. Furthermore, certain embodiments will allow full independence between the income insurance and the underlying investment, and allow such SALBs to be provided broadly and at an economical price.

SALBs and other similar products establish a guaranteed withdrawal base (GWB) for each investor. The GWB increases with all new contributions to the selected funds as well as increases with market gains. The GWB, however, does not decrease with market losses, as the insurance company is able to hedge the investments against such losses. In one embodiment, the investor receives guaranteed lifetime withdrawals (single or joint life) based on the high-water mark of the GWB. Thus, the payment amount can increase over time due to market increases. There may also be guaranteed payments set at a required minimum distribution (RMD). Once payments are initiated (e.g., upon retirement or some fixed date), the income payments are made from the investor's account. If the investor's account is exhausted before death (or other contractually stipulated end date), the insurance company will satisfy the remaining payments.

While SALB and like products are designed to be simple and easily understood by the investor, independence between the income insurance contract and the underlying investment introduces substantial complexity and effort in their support. The open choice provided to the investor and the independence of the insurance income guarantee from the investments involves synchronization and integration between the insurance companies, the investor, and the custodians of the underlying assets. Thus, in one embodiment, an independent investment platform provides an interface between these parties. The independent investment platform facilitates investor enrollment and formation of the income insurance contract between the investor and the insurance company and allows the investor to select independent investment held by a custodian of the investors choosing. Over time, the independent investment platform monitors the investments and ensures that they satisfy investment policies set by the insurance company. The independent investment platform can notify the insurance company of the status of individual investor accounts as well as inform the investor if changes are needed to bring their account into compliance. Finally, the independent investment platform can facilitate payments to the investor upon retirement.

In one embodiment, the independent investment platform monitors the investment account and automates the services used for the proper and cost effectiveness initiation, servicing, and pay-out of SALBs with open architecture for underlying investments. The investor, or a financial advisor selected by the investor, will have a single platform to provide all of the support and product needs, including all services requiring insurance licensing. In addition, the insurance companies will have a distribution channel in which all client product packaging and services are provided.

Embodiments of the present invention allow investors and/or their advisors to use a website to check on current income management contracts including up-to-date guaranteed minimum withdrawal amounts, guaranteed withdrawal base, contract fees, and withdrawal schedules. This information is also available for electronic download so that investor or their advisors can transfer the data to their internal portfolio management, relationship management, and client reporting systems. Business logic is automated in several operations components, which will be called as services from the website. Operations include workflow, data transfer with custodians and insurance companies, key account calculations, and business intelligence. The existing transfer protocols and file formats used by the insurance companies, custodians, and any advisor portfolio management software may be leveraged, so as not to provide service interruptions.

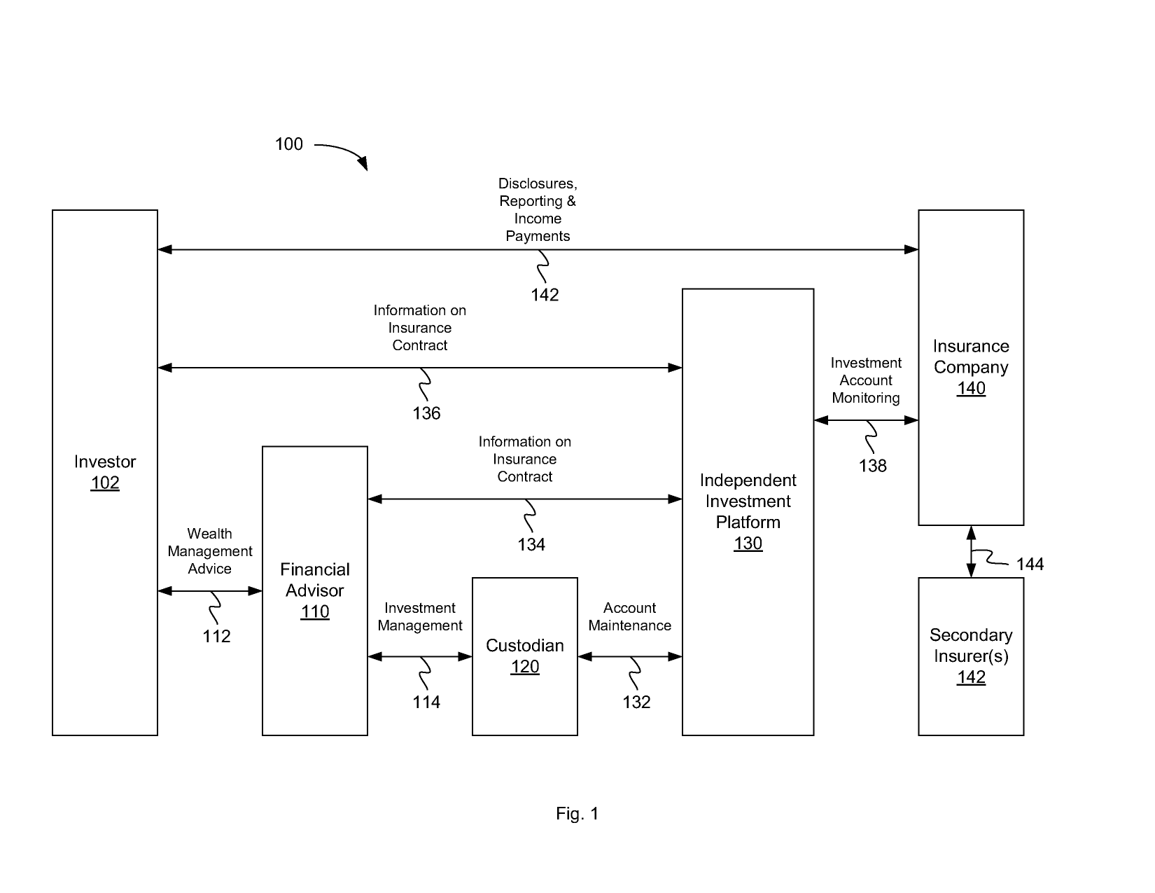

FIG. 1 is a block diagram illustrating an exemplary network architecture in which embodiments of the present disclosure may be implemented. The network architecture 100 can include an investor 102, a financial advisor 110, a custodian 120, independent investment platform 130 and insurance company 140. In one embodiment, each of investor 102, a financial advisor 110, a custodian 120, independent investment platform 130 and insurance company 140 may include a computing device, such as a server computer, gateway computer, desktop computer, laptop computer, mobile communications device, cell phone, smart phone, hand-held computer, tablet computer, or similar computing device. Communication between investor 102, a financial advisor 110, a custodian 120, independent investment platform 130 and insurance company 140 may be performed over a network (not shown), such as a local area network (LAN), a wireless network, a telephone network, a mobile communications network, a wide area network (WAN), such as the Internet, or similar communication system.

Investor 102 is typically an individual, although investor 102 may include groups of individuals and/or organizations. Investor 102 is investing their individual funds for retirement, for example, by purchasing income insurance from insurance company 140. Investor 102 invests an amount of money, referred to as the principle, and the insurance company guarantees that the principle will provide a set amount of income for the lifetime of the investor 102. Independent investment platform 130 provides an interface between investor 102 and insurance company 140 to allow the investor 102 to select independent investments for use with the income insurance product. In one embodiment, the investor 102 hires a financial advisor 110 to provide wealth management advice 112 with respect to what assets to purchase for investment. On behalf of investor 102, financial advisor 110 may invest money with custodian 120. Custodian 120 may be a specialized financial institution responsible for safeguarding financial assets. Custodian 120 may be, for example, a financial services company or brokerage and banking company, such as Charles Schwab, Fidelity Investments, TD Ameritrade or other Company. In one embodiment, custodian 120 is completely independent from insurance company 140, such that insurance company 140 has no input, influence or control over the actions and accounts of custodian 120 and/or there is no contractual relationship between the insurance company 140 and custodian 120. In one embodiment, custodian 120 may have no knowledge that the investments held by custodian 120 are being used in connection with an income insurance product offered by insurance company 140. In one embodiment, custodian 120 may have a marketing or distribution arrangement with insurance company 140, however this or other similar relationship may not affect the independence between custodian 120 and insurance company 140. The financial advisor 110 may perform investment management 114 with respect to the investor's account with custodian 120 by buying and selling particular assets. In another embodiment, investor 102 performs their own investment management 114 directly with custodian 120.

Although the investments held by custodian 120 are independent from insurance company 140, insurance company 140 still needs some amount of oversight in order to ensure they can perform with respect to the income guarantee. Independent investment platform 130 performs periodic account maintenance 132 on custodian 120 to monitor the status of the investments being used with the income insurance provided by insurance company 140. For example, at the close of every day, independent investment platform 130 may receive investor account information from custodian 120, including what investments are held and in what amounts, any transactions performed since the last update, and the vale of the investments. Independent investment platform 130 may compare this investment information to a series of one or more policies defined by insurance company 140. These investment policies are put in place by the insurance company 140 to ensure that it will be able to provide income for the user's lifetime. For example, the policies may define what types of investments are allowed and in what proportion certain investments may be held. In other words, in some embodiments, the policies may state that investments held in the investment account with custodian 120 should match those on a list of authorized investments allowed under the income insurance policy, and the proportion of those investments, relative to the other investments in the account, should match percentages defined by the insurance company 140. Independent investment platform 130 may provide investment account monitoring 138 to report the status of investor accounts (e.g., in compliance with investment policies or not) held by custodian 120 to insurance company 140. If independent investment platform 130 determines that the assets in the investment account are not in compliance with the investment policies, independent investment platform 130 may notify the financial advisor 110 or investor 102 by providing information on the insurance contract 134, 136, respectively.

Upon reaching retirement, or other contractually agreed upon date (e.g., a certain age of investor 102), the investor 102 may begin receiving income payments based on the income insurance contract. Initially, the payments may be made from the assets in the investment account held by custodian 120 in amounts determined by the insurance company 140. If the assets in the investment account are exhausted and additional payments are due (e.g., because the investor is still alive), the insurance company 140 may make the remaining payments 142 to investor 102. In certain embodiments, insurance company 140 may engage in risk sharing 144 by diversifying the income guarantee across one or more secondary insurers. 142. Additional details of independent investment platform 130 will be provided below.

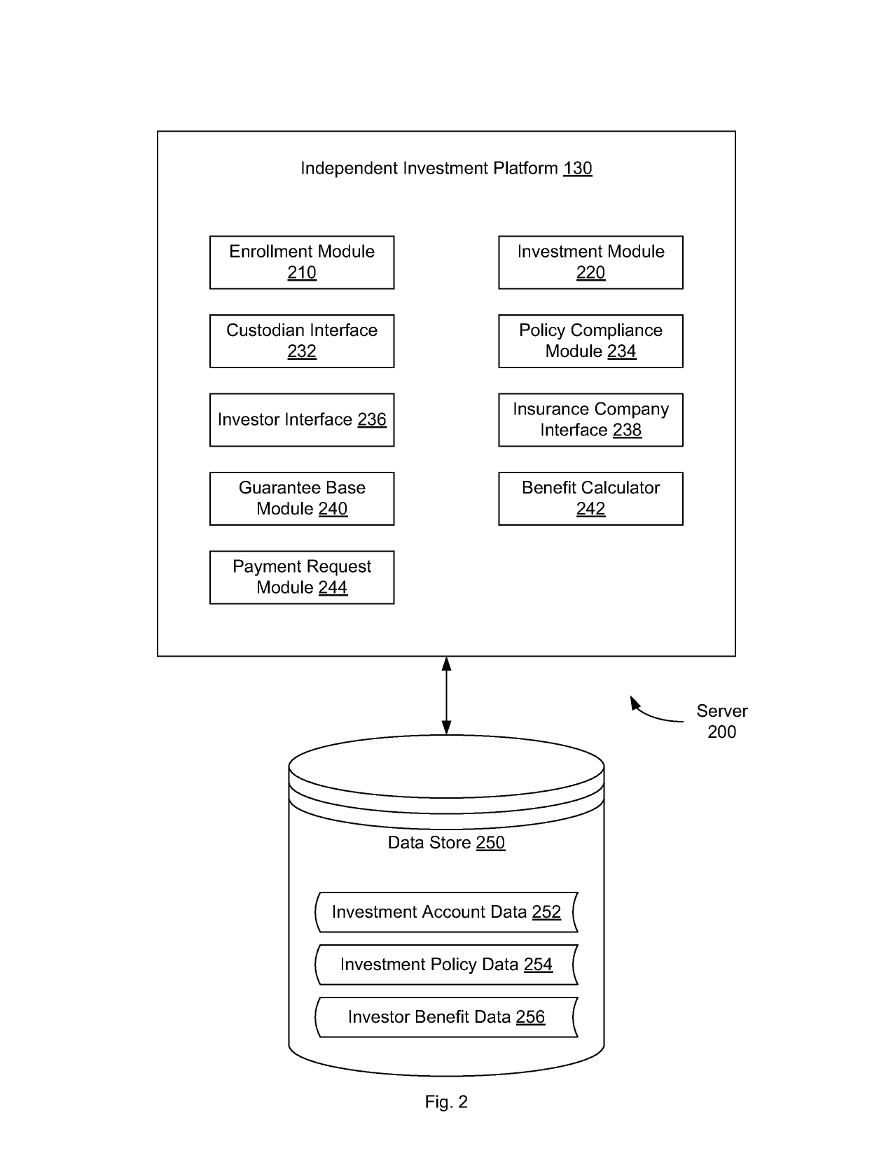

FIG. 2 is a block diagram illustrating an independent investment platform 130, according to an embodiment. In one embodiment, independent investment platform 130 includes enrollment module 210, investment module 220, custodian interface 232, policy compliance module 234, investor interface 236, insurance company interface 238, guarantee base module 240, benefit calculator 242, and payment request module 244. This arrangement of modules may be a logical separation, and in other embodiments, these modules or other components can be combined together or separated in further components, according to a particular embodiment. In one embodiment, storage device 250 is connected to independent investment platform and includes investment account data 252, investment policy data 254 and investor benefit data 256. In one embodiment, a server 200 may include independent investment platform 130 and storage device 250. In another embodiment, storage device 250 may be external to server 200 and may be connected to server 200 over a network or other connection. In other implementations, server 200 may include different and/or additional components which are not shown to simplify the description. Storage device 250 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, enrollment module 210 facilitates the enrollment of an investor in an income insurance policy using an independent investment platform. Enrollment module 210 may provide an interface to the investor 102 (e.g., on a website over a channel secured by secure-socket-layer (SSL)) to receive investor information to complete an application for enrollment in the income insurance product. Enrollment module 210 guides the investor 102 through the application and its terms and screens the application for correctness and completeness in real time as the investor 102 completes the application. The information provided by the investor may be as defined by legal requirements for contracts and for suitability review.

Enrollment module 210 further receives a selection of independent investments for use with the income insurance product. The investor 102 may select from a list of approved investment vehicles (e.g., mutual funds and exchange traded funds). This list may be provided by insurance company 140 and may be determined by the ability of the insurance company 140 to hedge those investments within the pricing of the income insurance product. If the desired investments are not on the approved list, then the investor 102 or advisor 110 may request the addition of other investment vehicles to the list. The nature of the investment may determine the price of the insurance income guarantee product. Enrollment module 210 may also determine a suitability of the investor 102 and the selected investments for use with the income insurance product. In one embodiment, this determination is automated and then subject to supervisory review, as required by law. The determination may be a function of the investor's stated assets and investable wealth (w), their stated investment objectives (o), and their stated risk tolerance (t), such that: Suitability=f(w, o, t). If enrollment module 210 determines that the investor 102 does not pass the suitability review, then a consultation may be initiated between the insurance company 140 and the investor 102 to select more appropriate investments.

In addition, enrollment module 210 may provide a prospectus to investor 102 (e.g., via e-mail). The required prospectus or prospectuses may be determined by state and Federal law. Enrollment module 210 may also provide any other disclosures required by state or Federal securities, insurance, or contract law. In addition, enrollment module 210 may also make all information and documents available for download on the secure web site. If the investor 102 and their proposed investments pass the suitability review, enrollment module may complete an application form using data provided by the investor 102 and deliver this form to the investor 102 via the web site for download, printing, and signature (or electronic signature) by the investor 102, and/or their advisor 110.

In one embodiment, investment module 220 verifies investments for use with the income insurance policy. Since the investor 102 is able to independently select investments for use with the income insurance product, the investor 102, or their advisor 110 may open a new account at the custodian 120 of their choice, fund the account at the custodian 120, and purchase the chosen and approved investments. Investment module 220 may receive a notification, indicating the investments and the investment account from one of investor 102, advisor 110 or custodian 120. Using the legal authority provided by the investor during enrollment, investment module 220 may confirms the investment in the investor's account at the custodian 120. This confirmation may be done using electronic protocols and file formats currently used currently in the investment management business, and will be apparent to one having ordinary skill in the art. Investment module 220 may then notify insurance company 140 that all enrollment documents are complete, that the investment is purchased in the account, the investment amount, and of the contract terms. This data may be transferred electronically using standard insurance industry protocols and data formats. Finally, investment module 220 may notify investor 102 that the contract is effective and provide a policy statement and effective date to the investor 102, and, if applicable, a copy to their advisor 110.

In one embodiment, custodian interface 232 downloads data on the investment account from the custodian 120. Custodian interface 232 may reconcile the account position with known purchases and sales of investments by the investor 102 and/or their financial advisor 110. Custodian interface 232 may perform this confirmation is done using electronic protocols (e.g., SSL and secure file transfer protocol (FTP)) and file formats (e.g., comma separate values (CSV) and extensible markup language (XML)) currently used in the investment management business. In one embodiment, this download and reconciliation is a nightly batch process executed by custodian interface 232 after close of the stock markets one day and before the opening of the stock markets the next day. Custodian interface 232 may store the resulting data as investment account data 252 in data store 250.

In one embodiment policy compliance module 234 determines if the investments in the investment account are in compliance with the investment policies allowed by the contract. Policy compliance module 234 may receive the investment policies from insurance company 140 and store them as investment policy data 254 in data store 250. The investment policies may define, for example, specific approved securities (set AS) and the proportional mix of the investment types (min₁, min₂, . . . minₙ) and (max₁, max₂, . . . maxₙ). Generally the determination is based on the proportion of the Investor's portfolio in each investment type (p₁, p₂, . . . pₙ), the specific securities in the portfolio (s₁, s₂, . . . s_{y}), and the contractually agreed allowed deviation (d), such that: Compliance=f(p, s, d). The function f( )may vary with the contract, but generally is determined by whether both of the following are true: Minⱼ−d<pⱼ<maxⱼ−d and sₖ∈AS, for all j=1 to n and all k=1 to y.

If policy compliance module 234 determines that the investment is outside the bound of the insurance contract (i.e., not incompliance with investment policy data 254), investor interface 236 may inform the investor 102 via email and insurance company interface 238 may inform insurance company 140 via real-time electronic connections. The investor 102 may be allowed a set period of time (as defined by the insurance contract) to correct any deviations from the investment policy. In one embodiment, investor interface 236 may provide a notification of the failed compliance check and/or instructions for bringing the investments into compliance to the investor 102 and/or the financial advisor 110. In one embodiment, policy compliance module 234 includes a timer that monitors that the compliance check. If the timer expires before the investment is compliant with the investment policy, investor interface 236 may notify the investor 102 and insurance company interface 238 may notify insurance company 140 that the contract is null and void.

In one embodiment, guarantee base module 240 calculates the new guarantee base as a result of any changes to bring the investments incompliance with the investment policies, using the data received from custodian 120. The guarantee base calculation may be a function of the original investment amount (o), additional contributions (c), withdrawals (w), market appreciation (m), the high water mark (h), and a contractually agreed period for resetting the guarantee base (p). In other words: New Guarantee Base (B)=f(o, c, w, m, h, p). The function f( )may vary with the contract, but may generally be determined by: If w=0.0 (i.e., there have been no withdrawals), then greatest of B₋₁+c; B₋₁+c+m; or h, where B₋₁ is the guarantee base at the end of the previous period. If w>0.0 (i.e., there have been withdrawals), then greatest of B₋₁+c−w; or B₋₁+c−w+m, where B₋₁ is the guarantee base at the end of the previous period. Guarantee base module 240 may notify investor 102 and/or advisor 110 of the new guarantee base via email and a secure web site.

In one embodiment, upon the investor 102 reaching the designated time when they are to begin receiving benefits, benefit calculator 242 calculates the benefits available to the investor 102 should the investor 102 wish to begin withdrawals. The benefits available for withdrawal under the income insurance agreement are determined by benefit calculator 242 using the guarantee base (g), the determined prevailing interest rate (r), the Investor's age (a), and the nominal Investor age for full withdrawal benefits as contractually agreed (n), such that: Benefits Available=f(g, r, a, n). The function f( ) may vary with the contract, but may generally be determined as: If a>n, then g*f′(r, a) where f′( )is a table built from actuarial data including life expectancies and probability distributions of investment returns. If a<n, then the benefit is 0.0. Benefit calculator 242 may inform investor 102, financial advisor 110 and/or insurance company 140 of the benefits available via email or other prearranged electronic protocols.

If the Investor's age (a) exceeds the nominal Investor age for full withdrawal benefits (n), then payment request module 244 may calculate a schedule for the investor 102, and their advisor 110, of the withdrawal amounts from the investor's account at the custodian 120 and the planned payment dates. Payment request module 244 may store this information as investor benefit data 25 in data store 250. If the investor's account at the custodian 120 has been depleted before the investor dies (or is otherwise still contractually entitled to income payments), then payment request module 244 may notify the insurance company 140 and the investor 102 that the next and future benefits will be paid by the insurance company 140.

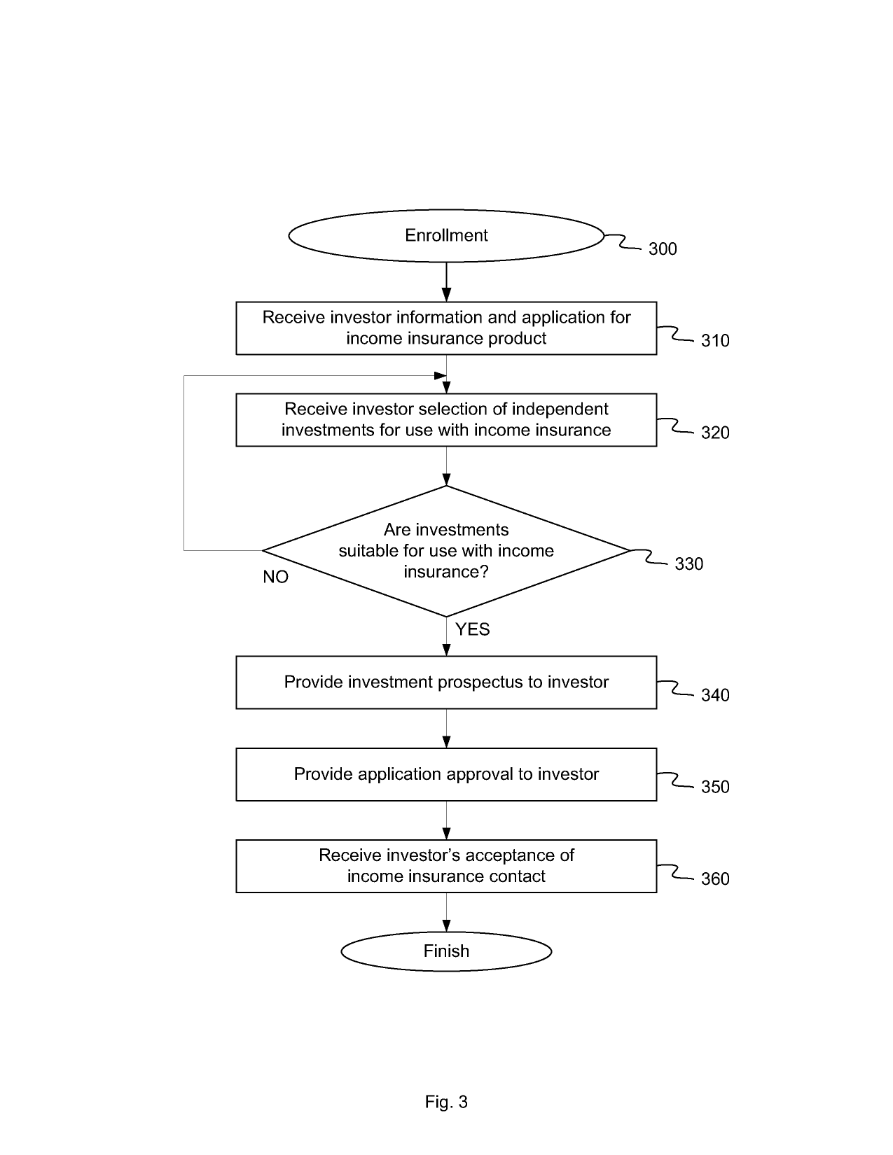

FIG. 3 is a flow diagram illustrating a method for enrollment in an income insurance policy using an independent investment platform, according to an embodiment. The method 300 may be performed by processing logic that comprises hardware (e.g., circuitry, dedicated logic, programmable logic, microcode, etc.), software (e.g., instructions run on a processing device to perform hardware simulation), or a combination thereof. The method 300 can enroll an investor in an income insurance policy using independent investments. In one embodiment, method 300 may be performed by independent investment platform 130, as shown in FIGS. 1 and 2.

Referring to FIG. 3, at block 310, method 300 receives investor information and application for the income insurance product. In one embodiment, enrollment module 210 may provide an interface to the investor 102 (e.g., on a website over a channel secured by secure-socket-layer (SSL)) to receive investor information to complete an application for enrollment in the income insurance product. Enrollment module 210 guides the investor 102 through the application and its terms and screens the application for correctness and completeness in real time as the investor 102 completes the application.

At block 320, method 300 receives the investor selection of independent investments for use with the income insurance product. Enrollment module 210 further receives a selection of independent investments for use with the income insurance product. The investor 102 may select from a list of approved investment vehicles (e.g., mutual funds and exchange traded funds). This list may be provided by insurance company 140 and may be determined by the ability of the insurance company 140 to hedge those investments within the pricing of the income insurance product. If one or more desired investments are not on the approved list, then the investor 102 or advisor 110 may request the addition of other investment vehicles to the list. The nature of the investment may determine the price of the insurance income guarantee product.

At block 330, method 300 determines whether the selected investments are suitable for use with the income insurance product. In one embodiment, enrollment module 210 determines the suitability as a function of the investor's stated assets and investable wealth (w), their stated investment objectives (o), and their stated risk tolerance (t), such that: Suitability=f(w, o, t). The function determines whether the insurance company 140 will be able to hedge the selected investments in such as way as to provide guaranteed income for the lifetime of the particular investor 102. If enrollment module 210 determines that the investor 102 does not pass the suitability review, then a consultation may be initiated between the insurance company 140 and the investor 102 to select more appropriate investments.

If at block 330, method 300 determines that the investments are suitable for use with the income insurance product, at block 340, method 300 provides an investment prospectus to the investor. Enrollment module 210 may provide the prospectus to investor 102 (e.g., via e-mail). The required prospectus or prospectuses may be determined by state and Federal law. Enrollment module 210 may also provide any other disclosures required by state or Federal securities, insurance, or contract law. In addition, enrollment module 210 may also make all information and documents available for download on the secure web site.

At block 350, method 300 provides a notification of application approval to the investor. In one embodiment, enrollment module 210 may complete an application form using data provided by the investor 102 and deliver this form to the investor 102 via the web site for download, printing, and signature (or electronic signature) by the investor 102, and/or their advisor 110. At block 360, method 300 receives the investor's acceptance of the income insurance contract.

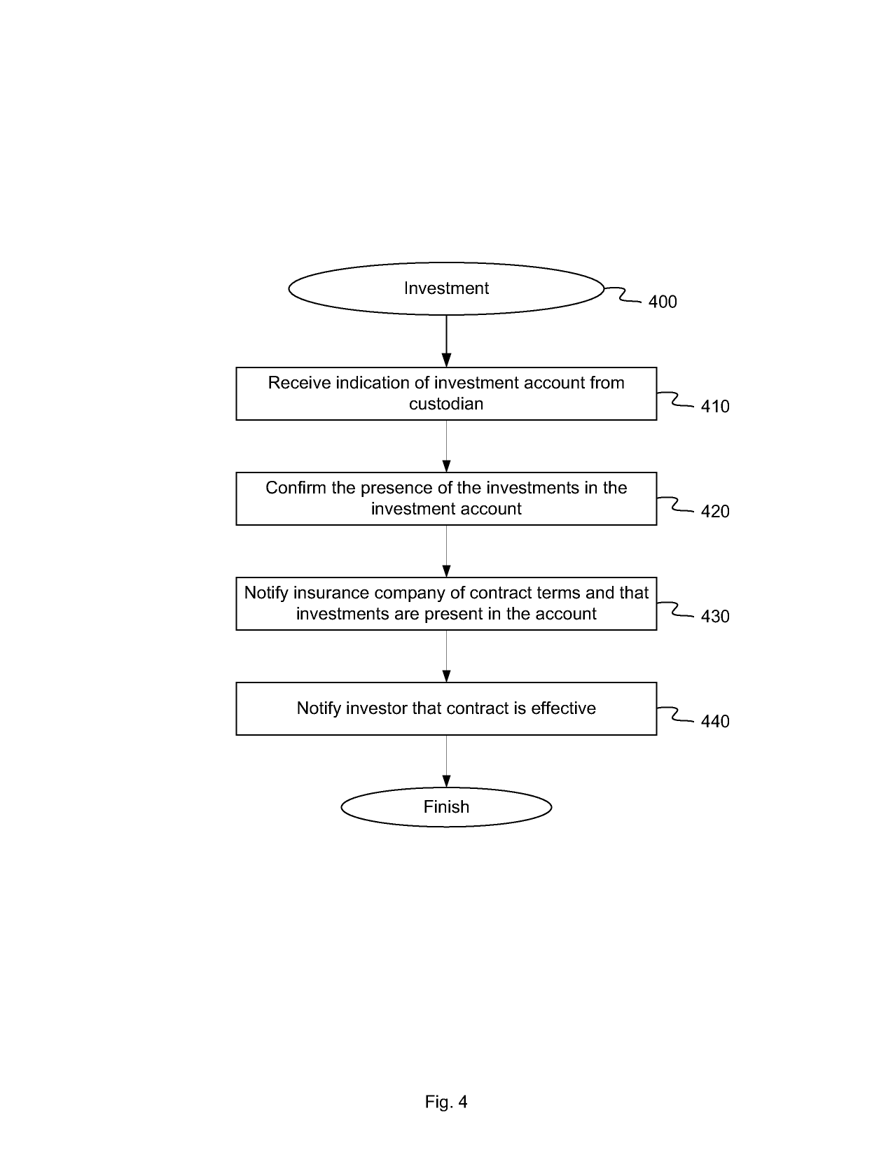

FIG. 4 is a flow diagram illustrating a method for verifying investments for use with an income insurance policy using an independent investment platform, according to an embodiment. The method 400 may be performed by processing logic that comprises hardware (e.g., circuitry, dedicated logic, programmable logic, microcode, etc.), software (e.g., instructions run on a processing device to perform hardware simulation), or a combination thereof. The method 400 can verify independent investments for use with an income insurance policy. In one embodiment, method 400 may be performed by independent investment platform 130, as shown in FIGS. 1 and 2.

Referring to FIG. 4, at block 410, method 400 receives an indication of an investment account from custodian 120. Since the investor 102 is able to independently select investments for use with the income insurance product, the investor 102, or their advisor 110, may open a new account at the custodian 120 of their choice, fund the account at the custodian 120, and purchase the chosen and approved investments. Investment module 220 may receive a notification, indicating the investments and the investment account, from one of investor 102, advisor 110 or custodian 120.

At block 420, method 400 confirms the presence of the investments in the investment account. Using the legal authority provided by the investor during enrollment, investment module 220 may confirms the investment in the investor's account at the custodian 120. This confirmation may be done using electronic protocols and file formats currently used currently in the investment management business, and will be apparent to one having ordinary skill in the art.

At block 430, method 400 notifies the insurance company 140 of the contract terms and that the investments are present in the investment account. In one embodiment, investment module 220 may notify insurance company 140 that all enrollment documents are complete, that the investment is purchased in the account, of an identifier of the investment amount, and of the contract terms. This data may be transferred electronically using standard insurance industry protocols and data formats.

At block 440, method 400 notifies the investor that the contract is effect. Investment module 220 may notify investor 102 that the contract is effective and provide a policy statement and effective date to the investor 102, and, if applicable, a copy to their advisor 110.

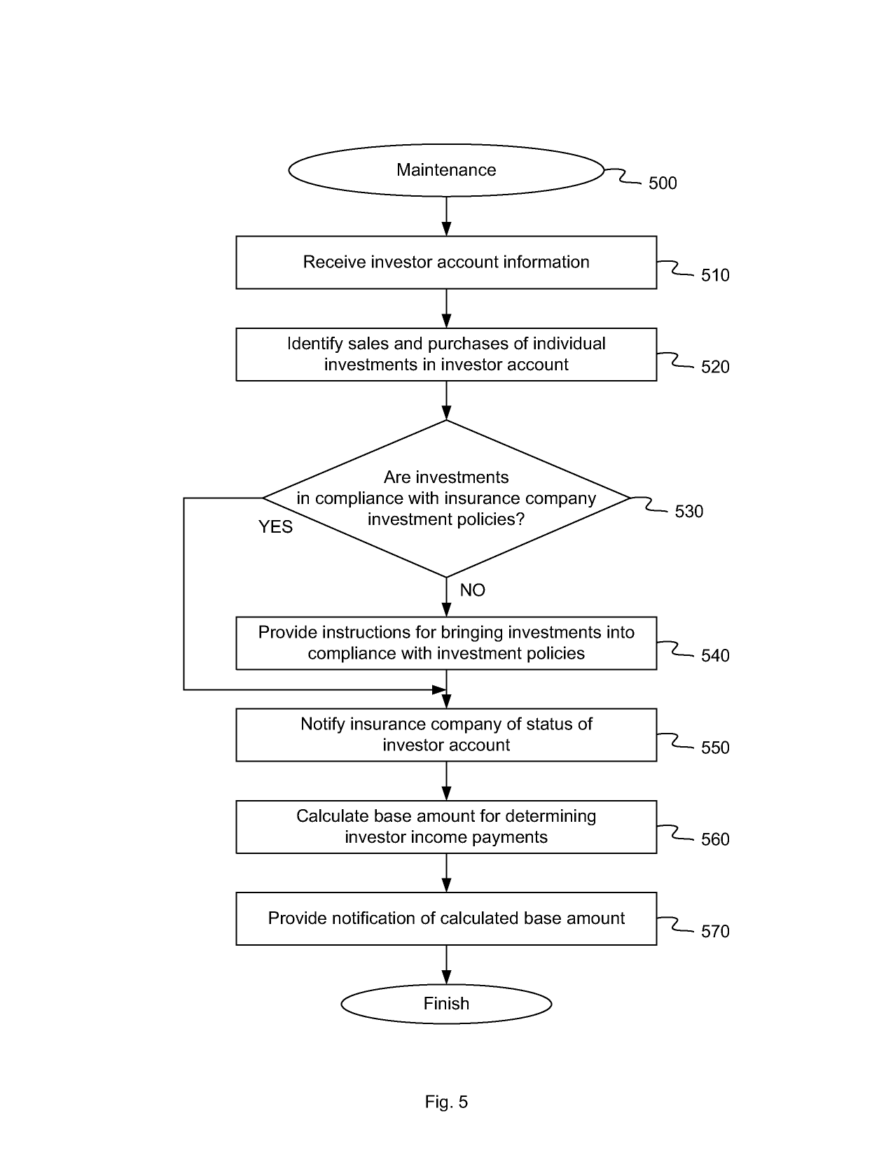

FIG. 5 is a flow diagram illustrating a maintenance method for monitoring independent investments used with an income insurance policy, according to an embodiment. The method 500 may be performed by processing logic that comprises hardware (e.g., circuitry, dedicated logic, programmable logic, microcode, etc.), software (e.g., instructions run on a processing device to perform hardware simulation), or a combination thereof. The method 500 can periodically monitor the independent investments used with an income insurance product to determine whether they are in compliance with investment policies. In one embodiment, method 500 may be performed by independent investment platform 130, as shown in FIGS. 1 and 2.

Referring to FIG. 5, at block 510, method 500 receives investor account information from custodian 120. In one embodiment, custodian interface 232 downloads data on the investment account from the custodian 120. Custodian interface 232 may receive the account information periodically (e.g., daily) or in response to a specific request. In one embodiment, the investor account information comprises an indication of investments held in the investment account, a relative proportion of the investments in the investment account, and a value of the investments in the investment account.

At block 520, method 500 identifies sales and purchases of individual investments in the investment account. In one embodiment, custodian interface 232 may reconcile the account position with known purchases and sales of investments by the investor 102 and/or their financial advisor 110. Custodian interface 232 may perform this confirmation is done using electronic protocols (e.g., SSL and secure file transfer protocol (FTP)) and file formats (e.g., comma separate values (CSV) and extensible markup language (XML)) currently used in the investment management business.

At block 530, method 500 determines whether the investments are in compliance with insurance company investment policies. The investment policies may define, for example, specific approved securities (set AS) and the proportional mix of the investment types (min₁, min₂, . . . minₙ) and (max₁, max₂, . . . maxₙ). Generally the determination is based on the proportion of the Investor's portfolio in each investment type (p₁, p₂, . . . pₙ), the specific securities in the portfolio (s₁, s₂, . . . s_{y}), and the contractually agreed allowed deviation (d), such that: Compliance=f(p, s, d). The function f( )may vary with the contract, but generally is determined by whether both of the following are true: Minⱼ−d<pⱼ<maxⱼ+d and sₖ∈AS, for all j=1 to n and all k=1 to y. In one embodiment, policy compliance module 234 may compare the investments to the investment policies to determine if they are in compliance. The result of the determination may be a binary result (e.g., either in compliance or not).

If at block 530, method 500 determines that the investments are not in compliance with the investment policies, at block 540, method 500 provides instructions to investor 102 for brining the investments into compliance with the investment policies. In one embodiment, investor interface 236 may inform the investor 102 via email. The investor 102 may be allowed a set period of time (as defined by the insurance contract) to correct any deviations from the investment policy. In one embodiment, investor interface 236 may provide a notification of the failed compliance check and/or instructions for bringing the investments into compliance to the investor 102 and/or the financial advisor 110. The instructions may include for example, what changes need to be made to the investments and their relative percentages in order to bring the account into compliance.

At block 550, method 500 notifies insurance company 140 of the status of the independent investor account held by custodian 120. In one embodiment, insurance company interface 238 provides a file to insurance company 140 listing the status (e.g., in compliance or not) of each independent investment account at custodian 120 that is associated with an income insurance policy provided by insurance company 140. In addition, insurance company interface 238 may also provide details of such accounts, including the investments that are held, the percentages they are held in, and the current value of those investments.

At block 560, method 500 calculates the guarantee base amount for determining investor payments. In one embodiment, guarantee base module 240 calculates the new guarantee base as a result of any changes to bring the investments incompliance with the investment policies, using the data received from custodian 120. The guarantee base calculation may be a function of the original investment amount (o), additional contributions (c), withdrawals (w), market appreciation (m), the high water mark (h), and a contractually agreed period for resetting the guarantee base (p). In other words: New Guarantee Base (B)=f(o, c, w, m, h, p). The function f( )may vary with the contract, but may generally be determined by: If w=0.0 (i.e., there have been no withdrawals), then greatest of B₋₁+c; B₋₁+c+m; or h, where B₋₁ is the guarantee base at the end of the previous period. If w>0.0 (i.e., there have been withdrawals), then greatest of B₋₁+c−w; or B₋₁+c−w+m, where B₋₁ is the guarantee base at the end of the previous period.

At block 570, method 500 provides a notification to investor 102 and insurance company 140 of the calculated guarantee base amount. Guarantee base module 240 may notify investor 102 and/or advisor 110 of the new guarantee base via email and a secure web site.

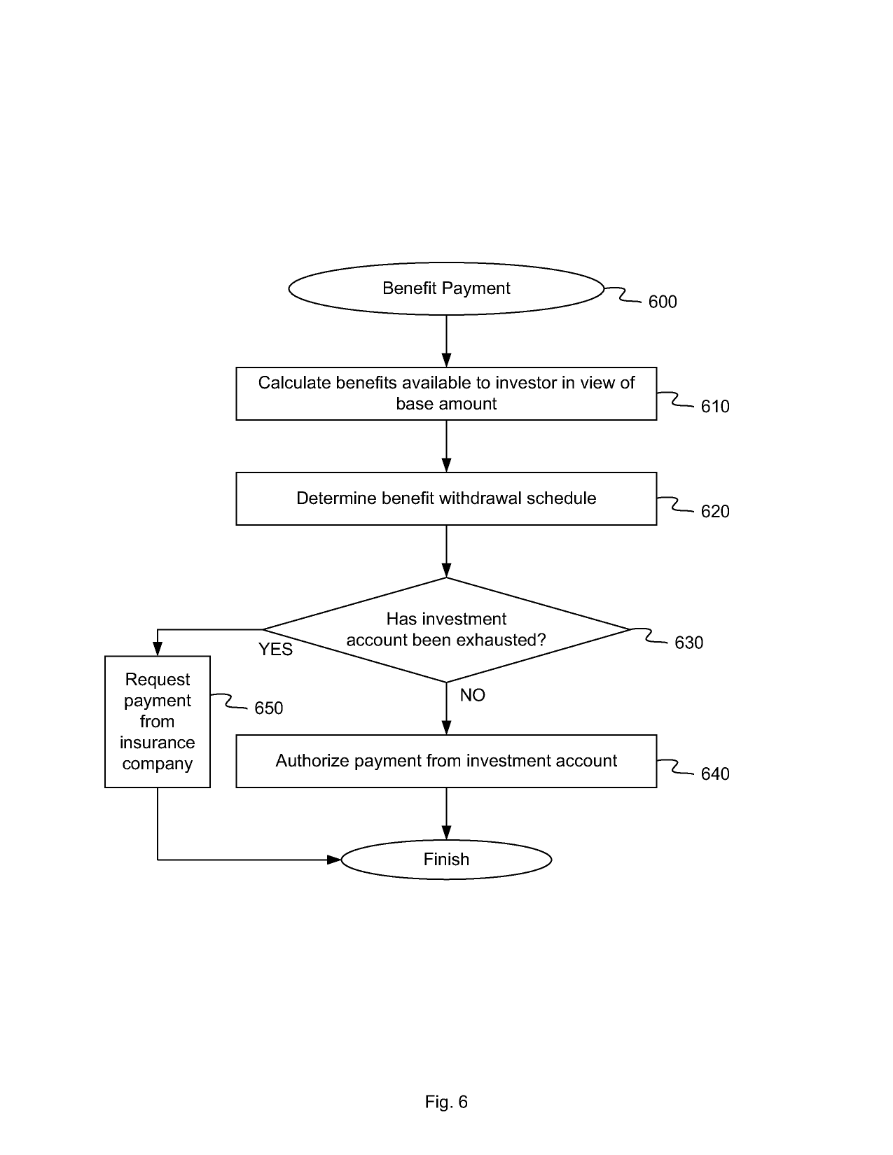

FIG. 6 is a flow diagram illustrating a method for benefit payments from an income insurance policy using an independent investment platform, according to an embodiment. The method 600 may be performed by processing logic that comprises hardware (e.g., circuitry, dedicated logic, programmable logic, microcode, etc.), software (e.g., instructions run on a processing device to perform hardware simulation), or a combination thereof. The method 600 can determine the amount of benefits to be paid to the user and facilitate payment of those benefits. In one embodiment, method 600 may be performed by independent investment platform 130, as shown in FIGS. 1 and 2.

Referring to FIG. 6, at block 610, method 600 calculates the benefits available to the investor 102 in view of the guarantee base amount. In one embodiment, benefit calculator 242 calculates the benefits available to the investor 102 should the investor 102 wish to begin withdrawals (i.e., investor income payments). The benefits available for withdrawal under the income insurance agreement are determined by benefit calculator 242 using the guarantee base (g), the determined prevailing interest rate (r), the Investor's age (a), and the nominal Investor age for full withdrawal benefits as contractually agreed (n), such that: Benefits Available=f(g, r, a, n). The function f( ) may vary with the contract, but may generally be determined as: If a>n, then g*f′(r, a) where f′( )is a table built from actuarial data including life expectancies and probability distributions of investment returns. If a<n, then the benefit is 0.0.

At block 620, method 600 determines a benefit withdrawal schedule for payment of the benefits. If the Investor's age (a) exceeds the nominal Investor age for full withdrawal benefits (n), then payment request module 244 may calculate a schedule for the investor 102, and their advisor 110, of the withdrawal amounts from the investor's account at the custodian 120 and the planned payment dates. The payment schedule may be an estimate based on the expected lifetime of the investor 102 and on the guaranteed withdrawal base (i.e., the amount of money available for the benefit payments).

At block 630, method 600 determines whether the investor's investment account has been exhausted in payment of the benefits. Initially, payments under the withdrawal schedule should be satisfied from the investor's investment account.

If at block 630, method 600 determines that the investor's account has not been exhausted, at block 640, method 600 authorizes payment of the benefits from the investment account. If money remains in the investment account, benefit payments may continue to be made from the account, thereby depleting its value further.

If at block 630, method 600 determines that the investor's account has been exhausted, at block 650, method 600 requests payment from the insurance company 140. Since the investor is guaranteed income payments under the terms of the contract, payment request module 244 may notify insurance company 140 that additional payments are needed. Insurance company 140 may then provide the benefit payments directly to investor 102 under the terms of the income insurance contract.

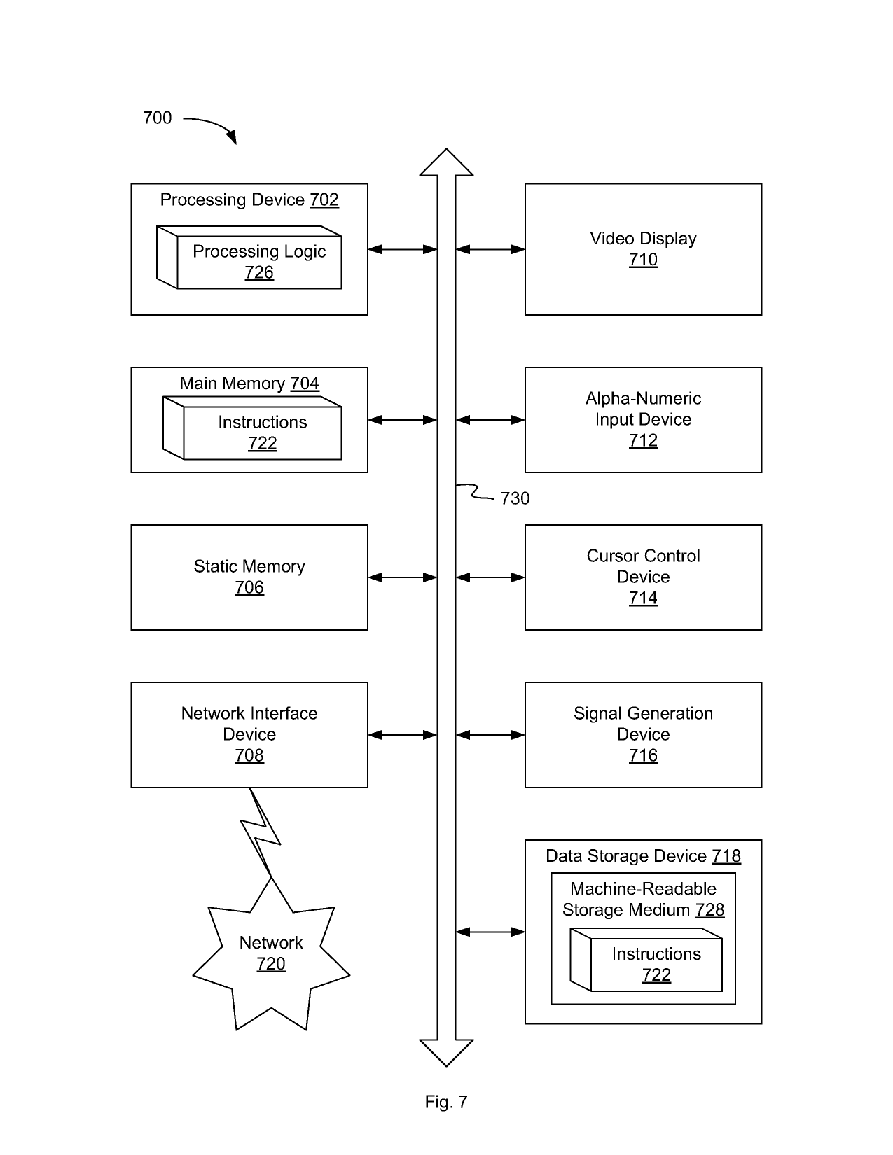

FIG. 7 illustrates a diagrammatic representation of a machine in the exemplary form of a computer system 700 within which a set of instructions, for causing the machine to perform any one or more of the methodologies discussed herein, may be executed. In alternative implementations, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one implementation, computer system 700 may be representative of a computing device, such as a server 200, used provide independent investment platform 130.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-readable storage medium 728, on which is stored one or more set of instructions 722 (e.g., software) embodying any one or more of the methodologies of functions described herein. The instructions 722 may also reside, completely or at least partially, within the main memory 704 and/or within the processing device 702 during execution thereof by the computer system 700; the main memory 704 and the processing device 702 also constituting machine-readable storage media. The instructions 722 may further be transmitted or received over a network 720 via the network interface device 708.

The machine-readable storage medium 728 may also be used to store instructions to perform a method for facilitating income insurance using independent underlying investments. While the machine-readable storage medium 728 is shown in an exemplary implementation to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the implementations included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive or.”

Although the operations of the methods herein are shown and described in a particular order, the order of the operations of each method may be altered so that certain operations may be performed in an inverse order or so that certain operation may be performed, at least in part, concurrently with other operations. In another implementation, instructions or sub-operations of distinct operations may be in an intermittent and/or alternating manner.

What is claimed is:

1. A method comprising:
receiving a request from an investor to purchase an income insurance product offered by an insurance company; and
monitoring, by a processing device, an investment account for use with the income insurance product, the investment account held by a custodian, wherein the investment account is independent of the insurance company.

2. The method of claim 1, wherein monitoring the investment account comprises:
receiving information about the investment account from the custodian; and
determining, based on the information, whether the investment account is in compliance with an investment policy provided by the insurance company.

3. The method of claim 2, wherein the information about the investment account comprises an indication of investments held in the investment account, a relative proportion of the investments in the investment account, and a value of the investments in the investment account.

4. The method of claim 2, further comprising:
if the investment account is not in compliance with the investment policy, providing instructions to the investor to bring the investment account into compliance with the investment policy.

5. The method of claim 2, further comprising:
notifying the insurance company of a status of the investment account, wherein the status indicates whether the investment account is in compliance with the investment policy.

6. The method of claim 1, further comprising:
calculating a guarantee base amount to determine investor income payments under the income insurance product; and
authorizing payments to the from the investment account based on the guarantee base amount.

7. The method of claim 6, further comprising:
if the investment account has been exhausted by investor income payments, requesting additional investor income payments from the insurance company.

8. A system comprising:
a custodian to hold an investment account owned by an investor;
an insurance company to provide an income insurance product to the investor; and
an independent investment platform comprising a processing device and a memory coupled to the processing device, the independent investment platform to:
receive a request from the investor to purchase the income insurance product offered by the insurance company; and
monitor the investment account for use with the income insurance product, wherein the investment account is independent of the insurance company.

9. The system of claim 8, wherein to monitor the investment account, the independent investment platform to:
receive information about the investment account from the custodian; and
determine, based on the information, whether the investment account is in compliance with an investment policy provided by the insurance company.

10. The system of claim 9, wherein the information about the investment account comprises an indication of investments held in the investment account, a relative proportion of the investments in the investment account, and a value of the investments in the investment account.

11. The system of claim 9, the independent investment platform further to:
if the investment account is not in compliance with the investment policy, provide instructions to the investor to bring the investment account into compliance with the investment policy.

12. The system of claim 9, the independent investment platform further to:
notify the insurance company of a status of the investment account, wherein the status indicates whether the investment account is in compliance with the investment policy.

13. The system of claim 8, the independent investment platform further to:
calculate a guarantee base amount to determine investor income payments under the income insurance product; and
authorize payments to the from the investment account based on the guarantee base amount.

14. The system of claim 13, the independent investment platform further to:
if the investment account has been exhausted by investor income payments, request additional investor income payments from the insurance company.

15. A non-transitory machine-readable storage medium storing instructions which, when executed, cause a processing device to perform operations comprising:
receiving a request from an investor to purchase an income insurance product offered by an insurance company; and
monitoring, by the processing device, an investment account for use with the income insurance product, the investment account held by a custodian, wherein the investment account is independent of the insurance company.

16. The non-transitory machine-readable storage medium of claim 15, wherein monitoring the investment account comprises:
receiving information about the investment account from the custodian; and
determining, based on the information, whether the investment account is in compliance with an investment policy provided by the insurance company.

17. The non-transitory machine-readable storage medium of claim 16, wherein the information about the investment account comprises an indication of investments held in the investment account, a relative proportion of the investments in the investment account, and a value of the investments in the investment account.

18. The non-transitory machine-readable storage medium of claim 16, the operations further comprising:
if the investment account is not in compliance with the investment policy, providing instructions to the investor to bring the investment account into compliance with the investment policy.

19. The non-transitory machine-readable storage medium of claim 16, the operations further comprising:
notifying the insurance company of a status of the investment account, wherein the status indicates whether the investment account is in compliance with the investment policy.

20. The non-transitory machine-readable storage medium of claim 15, the operations further comprising:
calculating a guarantee base amount to determine investor income payments under the income insurance product;
authorizing payments to the from the investment account based on the guarantee base amount; and
if the investment account has been exhausted by investor income payments, requesting additional investor income payments from the insurance company.
